SEQUENCE LISTING (32 sequences)

SEQ ID NO: 1 - DNA, 27 bp, artificial sequence
  Primer
gatctggtcatcgtcgccatgcatcac

SEQ ID NO: 2 - DNA, 24 bp, artificial sequence
  Primer
gccgacgactgggacgcgcagatg

SEQ ID NO: 3 - DNA, 26 bp, artificial sequence
  Primer
atgagctacgtcaccaccaaagatgg

SEQ ID NO: 4 - DNA, 585 bp, Pseudomonas putida 5B
gccgacgactgggacgcgcagatgctgttcttcctcgcccagggttaccgcgtggtcgcccacgaccggcggggccatggccgctccagccaggtatgggacggccacgacatggaccactatgccgacgacgtagccgccgtggtcgcccacctgggcacccagggcgccgtgcatgtcggccactcgaccggcggcggcgaagtggtgcgctacatggcccggcaccctgaagacaaggtggccaaggccgtgctgatcgcggccgtcccccccttgatggtacaaacccccggcaaccccggtggcctgcccaagtcggtattcgacggtttccaggcccaggttgccagcaaccgggcgcagttctaccgggatgtgccaacagggccgttctacggctacaaccgcccaggggtcgaagccagcgaaggcatcatcggcaactggtggcgccaaggcatgatcggcagtgcaaaggcccattacgatggcatcgtggcgttttcccagaccgatttcaccgaggacctgaagggcatccagcagccggtgctggtgatgcatggcgacgatgaccagatc

SEQ ID NO: 5 - DNA, 687 bp, Pseudomonas putida 5B
atgagctacgtcaccaccaaagatggcgtacagattttctacaaggactggggcccgcgcgatgcaccggtgatccacttccaccacggctggccgctcagtgccgatgactgggacgcgcagatgctgttcttcctcgcccagggttaccgcgtggtcgcccacgaccggcggggccatggccgctccagccaggtatgggacggccacgacatggaccactatgccgacgacgtagccgccgtggtcgcccacctgggcacccagggcgccgtgcatgtcggccactcgaccggcggcggcgaagtggtgcgctacatggcccggcaccctgaagacaaggtggccaaggccgtgctgatcgcggccgtcccccccttgatggtacaaacccccggcaaccccggtggcctgcccaagtcggtattcgacggtttccaggcccaggttgccagcaaccgggcgcagttctaccgggatgtgccaacagggccgttctacggctacaaccgcccaggggtcgaagccagcgaaggcatcatcggcaactggtggcgccaaggcatgatcggcagtgcaaaggcccattacgatggcatcgtggcgttttcccagaccgatttcaccgaggacctgaagggcatccagcagccggtgctggtgatgcatggcgacgatgaccagatc

SEQ ID NO: 6 - DNA, 24 bp, artificial sequence
  Primer
ggctacgtcgtcggcatagtggtc

SEQ ID NO: 7 - DNA, 27 bp, artificial sequence
  Primer
ggtggaagtggatcaccggtgcatcgc

SEQ ID NO: 8 - DNA, 23 bp, artificial sequence
  Primer
gcccattacgatggcatcgtggc

SEQ ID NO: 9 - DNA, 831 bp, Pseudomonas putida 5B
  CDS (1)..(831)
atgagctatgtaaccacgaaggacggcgtacagattttctacaaggactggggcccgcgcgatgcaccggtgatccacttccaccacggctggccgctcagtgccgatgactgggacgcgcagatgctgttcttcctcgcccagggttaccgcgtggtcgcccacgaccggcggggccatggccgctccagccaggtatgggacggccacgacatggaccactatgccgacgacgtagccgccgtggtcgcccacctgggcacccagggcgccgtgcatgtcggccactcgaccggcggcggcgaagtggtgcgctacatggcccggcaccctgaagacaaggtggccaaggccgtgctgatcgcggccgtcccccccttgatggtacaaacccccggcaaccccggtggcctgcccaagtcggtattcgacggtttccaggcccaggttgccagcaaccgggcgcagttctaccgggatgtgccaacagggccgttctacggctacaaccgcccaggggtcgaagccagcgaaggcatcatcggcaactggtggcgccaaggcatgatcggcagtgcaaaggcccattacgatggcatcgtggcgttttcccagaccgatttcaccgaggacctgaagggcatccagcagccggtgctggtgatgcacggcgacgatgaccagatcgtgccatacgaaaattccggggtactgtcggccaggctgctgcccaatggcacgctgaaaacctacaaaggctacccgcatggcatgcccaccacccatgccgatgtgatcaatgcggatttgctggcgtttatccgtagttga

SEQ ID NO: 10 - protein, 276 aa, Pseudomonas putida 5B
MSYVTTKDGVQIFYKDWGPRDAPVIHFHHGWPLSADDWDAQMLFFLAQGYRVVAHDRRGHGRSSQVWDGHDMDHYADDVAAVVAHLGTQGAVHVGHSTGGGEVVRYMARHPEDKVAKAVLIAAVPPLMVQTPGNPGGLPKSVFDGFQAQVASNRAQFYRDVPTGPFYGYNRPGVEASEGIIGNWWRQGMIGSAKAHYDGIVAFSQTDFTEDLKGIQQPVLVMHGDDDQIVPYENSGVLSARLLPNGTLKTYKGYPHGMPTTHADVINADLLAFIRS

SEQ ID NO: 11 - DNA, 33 bp, artificial sequence
  Primer
gaattcatgagctatgtaaccacgaaggacggc

SEQ ID NO: 12 - DNA, 40 bp, artificial sequence
  Primer
gcggccgcttaactacggataaacgccagcaaatccgcat

SEQ ID NO: 13 - DNA, 978 bp, Agrobacterium tumefaciens C58
  CDS (1)..(978)
atggcttccgatacagatcggtttttcgtgtcgagacgcagcgtactgctcgggagcctcgcacttgccagtgtgagcgttccggcactcgccttctcacacacctcttccacagacggttcatcacaaggagatatcgacatgggcttcgtaacaaccaaggacggcactgaaatcttttacaaggactggggtccaaaagacgcccagccgatcgtcttccaccacggctggccgctgtcgtcggacgattgggacgcgcagatgctgttcttcctctcgaagggctatcgcgtcgtcgcccacgacaggcgtggccatggccgctctgcccaggtcgccgatggtcacgatatggatcattatgccgccgacgccttcgcagtcgtccaggcactagacctgaagaacgccgtgcatatcggccactccaccggcggcggtgaagtcgcccgctatgtcgcaaaacacggccagaaggccggtcgcgttgccaaggctgtcctcgtctcggccgttccgccgctgatggtcaagaccacggccaaccctgagggtctgccaatcgaagtcttcgatggtttccgctcggcacttgccgccaaccgcgctcaattcttccgtgatgttccggccggcccgttctatggcttcaaccgggatggcgccaaggtgcaggagggcgtgatccagaattggtggcgccagggcatgatgggcggcgcaaaggctcattatgacggcatcaaggccttttccgaaaccgatcagacggaagacctgacggcgatcaccgtgccgacgctcgtcttgcacggcgaagacgaccagatcgtgccgatcgctgatgccgccaggaagtcgatcaagcttctgaagaacggtcagatcaagacctatccgggcttctcgcacggcatgctcaccgtcaacgccgacgttctcaatcaggacctgctagccttcatcaagggctga

SEQ ID NO: 14 - protein, 325 aa, Agrobacterium tumefaciens C58
MASDTDRFFVSRRSVLLGSLALASVSVPALAFSHTSSTDGSSQGDIDMGFVTTKDGTEIFYKDWGPKDAQPIVFHHGWPLSSDDWDAQMLFFLSKGYRVVAHDRRGHGRSAQVADGHDMDHYAADAFAVVQALDLKNAVHIGHSTGGGEVARYVAKHGQKAGRVAKAVLVSAVPPLMVKTTANPEGLPIEVFDGFRSALAANRAQFFRDVPAGPFYGFNRDGAKVQEGVIQNWWRQGMMGGAKAHYDGIKAFSETDQTEDLTAITVPTLVLHGEDDQIVPIADAARKSIKLLKNGQIKTYPGFSHGMLTVNADVLNQDLLAFIKG

SEQ ID NO: 15 - DNA, 29 bp, artificial sequence
  Primer
atgggcttcgtaacaaccaaggacggcac

SEQ ID NO: 16 - DNA, 30 bp, artificial sequence
  Primer
tcagcccttgatgaaggctagcaggtcctg

SEQ ID NO: 17 - DNA, 822 bp, Agrobacterium tumefaciens C58
  CDS (1)..(822)
atgtcgcgtttcaccaccactgacggtacccgcctcttttataaggactggggcgcagggcagccgatcctctttgcccacgggtggccgctgtcatccgatgcatgggaccagcagatgctgttcttcagccagaacggcttccgcgtcatcgcccacgatcgccgcagccatggccgctcggatcagacatttgacggcaacaacatggaccagtatgccgacgatctcgccgaactgatcaatgcactcgacctgtcggacctgatcttggttggccattcgaccggtggcggcgaggtctcgcattatgtcggccgtcatggcacggctcgtgttgccaaggtggttctggtgggtgcggtgccgccggtgatgctgaagaccgttgacaacccgaacggtacgccgatggaggtattcgacagtatccgcgaaaacaccgcgaagaaccgttcgcagtttttcttcgatctgacggtgcctttctacggctttaaccgggaaggtgtcgcgaccaatgacggcatgcgggaaaacttccgccgcataggactgcaaggcggcgtcaagggccagtacgattgcatccgggagttctctgaggtcgattacacccgtgatctgaagagtattgaccgcccgacgctgatcatccatggcgatgacgaccagatcgttccgatcgatgcatctgcccatcgggctgcggacctcgtggccgatgccacgctgaagatctattcgggcggctcccacggactggcagagactgaggctgatcgtttcaacgccgacgtgctcgcctttatccacggctga

SEQ ID NO: 18 - protein, 273 aa, Agrobacterium tumefaciens C58
MSRFTTTDGTRLFYKDWGAGQPILFAHGWPLSSDAWDQQMLFFSQNGFRVIAHDRRSHGRSDQTFDGNNMDQYADDLAELINALDLSDLILVGHSTGGGEVSHYVGRHGTARVAKVVLVGAVPPVMLKTVDNPNGTPMEVFDSIRENTAKNRSQFFFDLTVPFYGFNREGVATNDGMRENFRRIGLQGGVKGQYDCIREFSEVDYTRDLKSIDRPTLIIHGDDDQIVPIDASAHRAADLVADATLKIYSGGSHGLAETEADRFNADVLAFIHG

SEQ ID NO: 19 - DNA, 30 bp, artificial sequence
  Primer
atgtcgcgtttcaccaccactgacggtacc

SEQ ID NO: 20 - DNA, 28 bp, artificial sequence
  Primer
tcagccgtggataaaggcgagcacgtcg

SEQ ID NO: 21 - DNA, 828 bp, Agrobacterium tumefaciens C58
  CDS (1)..(828)
atgacaacgatcaccaccagagacggaacgcacatcttctacaaggactggggtccgaaagacggccagcccatcatcttctcccatggctggccgctcagcgccgacacctgggatgcgcagatggtgttcttcgccaataacggtttccgcaccatcgcccatgaccgccgcagccacggccgctcggatcaggtctggcacaacaataccatggatcaatatgccgacgatctcgccgagttgatcgaacagctcgatctccacgacatcattctagtcggtcattccaccggcggcggcgaggtgacccgttatatcggccgccacggcacggcccgcgtcgcgaagatcgccctcatcggcgcggtgccgccgctgatgctgaagacggaaagcaataccatcggcatgccgatcgatgtcttcgatggcatccgcaagagcacctatgataatcgcagccagttcttcaaggacctgaccattcccttctacggctacaaccgcgaaggcgccgtgatttcggaaggcattcgcgaggaattctggcggcagggcatgatgggcggcctcaagggccagctcgacagtatccgcgccttctcggaaagcgatttccaccaggacctgaaggccttcgacaaaccaacgctggtgctgcatggcgatgacgaccagatcgtgccggtcggcgcttcagcactttccacggtcaagatcgtcaaacatgcgaccctcaaaatctacgagggcgccgaccatggcctgacgcagacccatcaggaccggttcaacgccgacctcctcaccttcatcaacgcctga

SEQ ID NO: 22 - protein, 275 aa, Agrobacterium tumefaciens C58
MTTITTRDGTHIFYKDWGPKDGQPIIFSHGWPLSADTWDAQMVFFANNGFRTIAHDRRSHGRSDQVWHNNTMDQYADDLAELIEQLDLHDIILVGHSTGGGEVTRYIGRHGTARVAKIALIGAVPPLMLKTESNTIGMPIDVFDGIRKSTYDNRSQFFKDLTIPFYGYNREGAVISEGIREEFWRQGMMGGLKGQLDSIRAFSESDFHQDLKAFDKPTLVLHGDDDQIVPVGASALSTVKIVKHATLKIYEGADHGLTQTHQDRFNADLLTFINA

SEQ ID NO: 23 - DNA, 30 bp, artificial sequence
  Primer
atgacaacgatcaccaccagagacggaacg

SEQ ID NO: 24 - DNA, 28 bp, artificial sequence
  Primer
tcaggcgttgatgaaggtgaggaggtcg

SEQ ID NO: 25 - DNA, 31 bp, artificial sequence
  Primer
caattgatgacaacgatcaccaccagagacg

SEQ ID NO: 26 - DNA, 43 bp, artificial sequence
  Primer
caattgcggccgcttaggcgttgatgaaggtgaggaggtcggc

SEQ ID NO: 27 - DNA, 837 bp, Agrobacterium tumefaciens C58
  CDS (1)..(837)
atgggctttgttaagacgacagacggaaccgaaatcttttacaaggactggggcccgaaggatgcccagccgatcatgttccaccacggctggccgctctcgtccgatgattgggatgcgcagatgctgtttttcctctctaaaggttttcgtgttgtcgcccatgaccgccgtggtcacggccgctccgcccaggttgccgatggtcacgatatggaccactacgccgccgacgccttcgccgtcgttgaggcgctcgatctgaagaatgtcgtccatatcggccattccaccggtggcggcgaagtcgcccgttatgtcgccaagcatggcgaacccgccggccgcgttgccaaggcggttctcgtttccgcggtaccgccgctgatgctcaagaccgaggccaatccggaaggcctgccgatggaagtctttgacggcttccgctcagcccttgccgcaaaccgagcccagttcttccgcgacgtgccgtccggcccgttctacggcttcaaccgcgatggcgcgtccgtgcaggaaggcgtgatccagaactggtggcgtcagggcatgatgggcggcgcgaaggctcattatgacggcgtcaaggccttctccgaaaccgaccagactgaagacctgaagaatatcagcgttccaacgctcgttctccacggtgaagacgaccagatcgttccgattgccgactcggctcacaaatcggtcaagctgctgaagaacggcacgctgaagacttatcccgggttctcgcacggcatgctgacagtcaatgccgatgtgctgaatgcggatctgctggccttcatcaagggctga

SEQ ID NO: 28 - protein, 278 aa, Agrobacterium tumefaciens C58
MGFVKTTDGTEIFYKDWGPKDAQPIMFHHGWPLSSDDWDAQMLFFLSKGFRVVAHDRRGHGRSAQVADGHDMDHYAADAFAVVEALDLKNVVHIGHSTGGGEVARYVAKHGEPAGRVAKAVLVSAVPPLMLKTEANPEGLPMEVFDGFRSALAANRAQFFRDVPSGPFYGFNRDGASVQEGVIQNWWRQGMMGGAKAHYDGVKAFSETDQTEDLKNISVPTLVLHGEDDQIVPIADSAHKSVKLLKNGTLKTYPGFSHGMLTVNADVLNADLLAFIKG

SEQ ID NO: 29 - DNA, 30 bp, artificial sequence
  Primer
atgggctttgttaagacgacagacggaacc

SEQ ID NO: 30 - DNA, 28 bp, artificial sequence
  Primer
tcagcccttgatgaaggccagcagatcc

SEQ ID NO: 31 - DNA, 33 bp, artificial sequence
  Primer
atgaattcatgggctttgttaagacgacagacg

SEQ ID NO: 32 - DNA, 37 bp, artificial sequence
  Primer
atgcggccgctcagcccttgatgaaggccagcagatc

(19) United States
(12) Patent Application Publication
(10) Pub. No.: US 2007/0082832 A1
(43) Pub. Date: Apr. 12, 2007

(54) Enzymatic production of peracids from carboxylic acid ester substrates using non-heme haloperoxidases

(76) Inventors: Robert DiCosimo, Chadds Ford, PA (US); Mark S. Payne, Wilmington, DE (US); Lorraine W. Wagner, Newark, DE (US); John E. Gavagan, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/524,832

(22) Filed: Sep. 21, 2006

Related U.S. Application Data
(60) Provisional application No. 60/724,106, filed on Oct. 6, 2005.

(51) Int. Cl. C11D 3/386

(52) U.S. Cl. 510/305; 510/375

(57) ABSTRACT

A process is provided for producing peroxycarboxylic acids from carboxylic acid esters. More specifically, carboxylic acid esters are reacted in situ with an inorganic peroxide in the presence of a non-heme haloperoxidase having perhydrolysis activity to produce peroxycarboxylic acids.

This application claims the benefit of U.S. Provisional Application No. 60/724,106 filed Oct. 6, 2005.

### FIELD OF THE INVENTION

This invention relates to the field of peracid biosynthesis and in situ enzyme catalysis. Specifically, non-heme haloperoxidases having perhydrolysis activity were used to produce peracids from carboxylic acid ester substrates.

### BACKGROUND OF THE INVENTION

Peracid compositions have been reported to be effective antimicrobial agents. Methods to clean, disinfect, and/or sanitize hard surfaces, meat products, living plant tissues, and medical devices against undesirable microbial growth have been described (U.S. Pat. No. 6,545,047, U.S. Pat. No. 6,183,807, U.S. Pat. No. 6,518,307, US 20030026846, and U.S. Pat. No. 5,683,724). Peracids have also been reported to be useful in preparing bleaching compositions for laundry detergent applications (U.S. Pat. No. 3,974,082, U.S. Pat. No. 5,296,161, and U.S. Pat. No. 5,364,554).

Peracids can be prepared by the chemical reaction of a carboxylic acid and hydrogen peroxide (see Organic Peroxides, Daniel Swern, ed., Vol. 1, pp 313-516; Wiley Interscience, New York). A strong inorganic acid, such as concentrated sulfuric acid, usually catalyzes the reaction. The reaction of hydrogen peroxide with a carboxylic acid is an equilibrium reaction, and the production of peracid is favored by the use of an excess concentration of peroxide and/or carboxylic acid, or by the removal of water. There are several disadvantages to the chemical reaction for peracid production: a) the high concentration of carboxylic acid used to favor production of peracid can result in an undesirable odor when using the peracid-containing solution, 2) the peracid is oftentimes unstable in solution over time, and the concentration of peracid in the solution decreases during storage prior to use, and 3) the formulation is often strongly acidic due to the use of concentrated sulfuric acid as catalyst.

One way to overcome the disadvantages of the chemical production of peracids is to employ an enzyme catalyst in place of a strong acid catalyst. The use of an enzyme catalyst allows for the rapid production of peracid at the time of use and/or application, avoiding problems associated with storage of peracid solutions and variations in peracid concentrations over time. The high concentrations of carboxylic acids typically used to produce peracid via the direct chemical reaction with hydrogen peroxide are not required for enzymatic production of peracid, where the enzyme catalyzed reaction can use a carboxylic acid ester substrate at a much lower concentration than is typically used in the chemical reaction. The enzyme reaction can be performed across a broad range of pH, dependent on enzyme activity and stability at a given pH, and on the substrate specificity for perhydrolysis at a given pH.

Esterases, lipases, and some proteases have the ability to catalyze the hydrolysis of alkyl esters to produce the corresponding carboxylic acids (Formula 1).

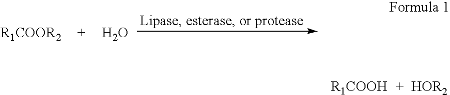

Some esterases, lipases and proteases exhibit perhydrolysis activity, catalyzing the synthesis of peracids from alkyl esters (Formula 2).

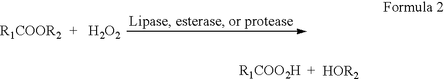

O. Kirk et al. (Biocatalysis, 11:65-77 (1994)) investigated the ability of hydrolases (lipases, esterases, and proteases) to catalyze perhydrolysis of acyl substrates with hydrogen peroxide to form peroxycarboxylic acids, and reported that perhydrolysis proceeds with a very low efficiency in aqueous systems. Furthermore, they found that lipases and esterases degraded percarboxylic acid to the corresponding carboxylic acid and hydrogen peroxide. The authors concluded that esterases, lipases and proteases are, in general, not suitable for catalyzing perhydrolysis of simple esters, such as methyl octanoate and trioctanoin, in an aqueous environment.

U.S. Pat. No. 3,974,082 describes the production of bleaching compositions for laundry detergent applications by contacting the material to be bleached with an aqueous solution containing an oxygen-releasing inorganic peroxygen compound, an acyl alkyl ester, and an esterase or lipase capable of hydrolyzing the ester.

U.S. Pat. No. 5,364,554 describes an activated oxidant system for in situ generation of peracid in aqueous solution using a protease enzyme, a source of hydrogen peroxide, and an ester substrate that is preferably chemically non-perhydrolyzable. A method of bleaching and a method of forming peracid are also disclosed.

U.S. Pat. No. 5,296,161 describes production of peracid in an aqueous solution comprising one or more specific esterases and lipases, a source of hydrogen peroxide, and a functionalized ester substrate suitable for use in a bleaching composition. However, the concentration of peracid produced was generally insufficient for use in many commercial disinfectant applications.

Most known methods for preparing peracids from the corresponding carboxylic acid esters using enzyme catalysts do not produce and accumulate a peracid at a sufficiently-high concentration to be efficacious for disinfection in a variety of applications. Several protease and lipase combinations have recently been reported to generate peracids (e.g. peracetic acid) in situ at concentrations suitable for use as a disinfectant and/or commercial bleaching agent (U.S. Ser. No. 11/413,246). However, there remains a need to identify additional enzyme catalysts capable of producing peracids in situ.

Haloperoxidases are widespread in nature, commonly found in animals, plants, bacteria, fungi, and algae. The first discovered haloperoxidases were reported to contain heme as a prosthetic group or cofactor. Subsequently, many non-heme haloperoxidases have been identified, primarily from bacteria.

Haloperoxidases catalyze the oxidation of halide ion (X═Cl, Br, or I) in the presence of hydrogen peroxide to the corresponding hypohalous acid (HOX), a reactive oxygen species that has been reported to have better antimicrobial activity than hydrogen peroxide (Formula 3).

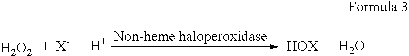

Plants recombinantly expressing a non-heme haloperoxidase from Pseudomonas pyrrocinia have been report to have improved pathogen resistance (Jacks et al., U.S. Pat. No. 6,703,540). Jacks et al. report that the recombinantly expressed non-heme haloperoxidase also exhibited the ability to catalyze a reaction between acetic acid and hydrogen peroxide, forming the antimicrobial agent peracetic acid. Increased production of hypohalites and peracetic acid in the transgenic plant were correlated with the increase in pathogen resistance. However, it was later reported that the increased resistance to the fungal pathogen Aspergillus flavus in transgenic plants expressing the P. pyrrocinia non-heme haloperoxidase was probably not due to peracetic acid formation as the concentration of the substrates (hydrogen peroxide or acetate) needed for enzyme saturation was lethal (to the fungal pathogen) prior to its oxidation to peracetate (Jacks et al., J. Agric. Food Chem. 48:4561-4564 (2000); Jacks et al., J. Agric. Food Chem., 50:706-709 (2002)).

The problem to be solved is to provide a process to enzymatically produce peracids in situ at concentrations suitable for use in a variety of disinfectant applications. Preferably, the substrates used to produce the peracid compositions should be relatively non-toxic and inexpensive, such as carboxylic acid esters.

### SUMMARY OF THE INVENTION

The stated problem has been solved by the discovery that non-heme haloperoxidases, in the presence of an inorganic source of peroxygen (e.g. hydrogen peroxide) and a carboxylic acid ester substrate, produce concentrations of peracids in situ sufficient for use as a disinfectant and/or bleaching agent.

In one aspect of the invention, an aqueous enzymatic process for in situ generation of peracids using a non-heme haloperoxidase in combination with selected substrates is provided comprising:
a) providing a set of peracid reaction components, said components comprising:
   1. a substrate selected from the group consisting:
      i) esters having the structure 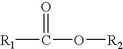
      wherein R₁=C1 to C10 straight chain or branched chain alkyl optionally substituted with an hydroxyl or C1 to C4 alkoxy group and R₂=C1 to C10 straight chain or branched chain alkyl group, (CH₂CH₂—O)ₙH or (CH₂CH(CH₃)—O)ₙH and n=1 to 10;
      ii) glycerides having the structure 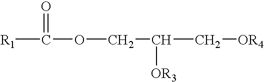
      wherein R₁=C1 to C10 straight chain or branched chain alkyl optionally substituted with an hydroxyl or a C1 to C4 alkoxy group and R₃ and R₄ are individually H or R₁C(O);
   2) a source of peroxygen; and
   3) a non-heme haloperoxidase catalyst having perhydrolysis activity;
b) combining said reaction components under aqueous reaction conditions whereby a peracid is produced at a concentration of at least 500 ppb within about 5 minutes to about 2 hours of combining the reaction components.

In another aspect of the invention, a process is provided to reduce a viable microbial population on a hard surface or inanimate object by contacting the peracid composition produced by the above process with a hard surface or inanimate object within 48-hours of mixing the peracid reaction components whereby the viable microbial population is reduced 25 at least 3-log, preferably 4-log, more preferably at least 5-log, and most preferably at least 6-log. In a further aspect, the peracid product produced by the above methods may be optionally diluted to a desired efficacious concentration prior to contacting the surface or inanimate object to be treated.

In a further aspect of the invention, a nucleic acid fragment encoding a non-heme haloperoxidase having perhydrolytic activity is also provided.

### BRIEF DESCRIPTION OF THE BIOLOGICAL SEQUENCES

The following sequences comply with 37 C.F.R. 1.821-1.825 (“Requirements for Patent Applications Containing Nucleotide Sequences and/or Amino Acid Sequence Disclosures—the Sequence Rules”) and are consistent with World Intellectual Property Organization (WIPO) Standard ST.25 (1998) and the sequence listing requirements of the EPC and PCT (Rules 5.2 and 49.5(a-bis), and Section 208 and Annex C of the Administrative Instructions). The symbols and format used for nucleotide and amino acid sequence data comply with the rules set forth in 37 C.F.R. §1.822.

SEQ ID NO: 1 is the nucleotide sequence of a primer#1.

SEQ ID NO: 2 is the nucleotide sequence of a primer#2.

SEQ ID NO: 3 is the nucleotide sequence of a primer#3.

SEQ ID NO: 4 is the nucleotide sequence amplified from Psuedomonas putida 5B (NRRL-18668) genomic DNA using primer#1 and primer#2.

SEQ ID NO: 5 is the nucleotide sequence amplified from Psuedomonas putida 5B (NRRL-18668) genomic DNA using primer#1 and primer#3.

SEQ ID NO: 6 is the nucleotide sequence of a primer#4.

SEQ ID NO: 7 is the nucleotide sequence of a primer#5.

SEQ ID NO: 8 is the nucleotide sequence of a primer#6.

SEQ ID NO: 9 is the nucleotide sequence of the coding region of a non-heme haloperoxidase from Pseudomonas putida 5B (NRRL-18668).

SEQ ID NO: 10 is the deduced amino acid sequence of the non-heme haloperoxidase from P. putida 5B (NRRL-18668).

SEQ ID NO: 11 is the nucleotide sequence of a primer#7.

SEQ ID NO: 12 is the nucleotide sequence of a primer#8.

SEQ ID NO: 13 is the nucleotide sequence of a non-heme haloperoxidase (“AtuA1”) from Agrobacterium tumefaciens C58 (GenBank® 16119616).

SEQ ID NO: 14 is the amino acid sequence of a non-heme haloperoxidase (“AtuA1”) from Agrobacterium tumefaciens C58 (GenBank® 16119616).

SEQ ID NO: 15 is the nucleotide sequence of a primer#9.

SEQ ID NO: 16 is the nucleotide sequence of a primer#10.

SEQ ID NO: 17 is the nucleotide sequence of a non-heme haloperoxidase (“AtuA2”) from Agrobacterium tumefaciens C58 (GenBank® 16119293).

SEQ ID NO: 18 is the amino acid sequence of a non-heme haloperoxidase (“AtuA2”) from Agrobacterium tumefaciens C58 (GenBank® 16119293).

SEQ ID NO: 19 is the nucleotide sequence of a primer#11.

SEQ ID NO: 20 is the nucleotide sequence of a primer#12.

SEQ ID NO: 21 is the nucleotide sequence of a non-heme haloperoxidase (“AtuA3”) from Agrobacterium tumefaciens C58 (GenBank® 15891475).

SEQ ID NO: 22 is the amino acid sequence of a non-heme haloperoxidase (“AtuA3”) from Agrobacterium tumefaciens C58 (GenBank® 15891475).

SEQ ID NO: 23 is the nucleotide sequence of a primer#13.

SEQ ID NO: 24 is the nucleotide sequence of a primer#14.

SEQ ID NO: 25 is the nucleotide sequence of a primer#15.

SEQ ID NO: 26 is the nucleotide sequence of a primer#16.

SEQ ID NO: 27 is the nucleotide sequence of a non-heme haloperoxidase (“AtuA4”) from Agrobacterium tumefaciens C58 (GenBank® 15891444).

SEQ ID NO: 28 is the amino acid sequence of a non-heme haloperoxidase (“AtuA4”) from Agrobacterium tumefaciens C58 (GenBank® 15891444).

SEQ ID NO: 29 is the nucleotide sequence of a primer#17.

SEQ ID NO: 30 is the nucleotide sequence of a primer#18.

SEQ ID NO: 31 is the nucleotide sequence of a primer#19.

SEQ ID NO: 32 is the nucleotide sequence of a primer#20.

### DETAILED DESCRIPTION OF THE INVENTION

An aqueous enzymatic process for in situ generation of peracids from a carboxylic acid ester substrate using a non-heme haloperoxidase having perhydrolase activity is provided herein.

In another aspect of the invention, a process is provided to reduce a viable microbial population on a hard surface or inanimate object by contacting the peracid composition produced by the above process with a hard surface or inanimate object within 48-hours of mixing the peracid reaction components whereby the viable microbial population is reduced at least 3-log, preferably 4-log, more preferably at least 5-log, and most preferably at least 6-log.

In this disclosure, a number of terms and abbreviations are used. The following definitions apply unless specifically stated otherwise.

As used herein, the term “comprising” means the presence of the stated features, integers, steps, or components as referred to in the claims, but that it does not preclude the presence or addition of one or more other features, integers, steps, components or groups thereof.

As used herein, the term “peracid” is synonymous with peroxyacid, peroxy acid, percarboxylic acid and peroxoic acid.

As used herein, the term “peracetic acid” is abbreviated as “PAA” and is synonymous with peroxyacetic acid, ethaneperoxoic acid and all other synonyms of CAS Registry Number 79-21-0.

As used herein, the term “a source of peroxygen” means a peroxygen compound (i.e., a “peroxygen source”) capable of providing hydrogen peroxide to the aqueous reaction mixture selected from the group consisting of perborate salts, percarbonate salts, perphosphate salts, hydrogen peroxide, hydrogen peroxide-urea adduct (CAS# 124-43-6), and mixtures thereof.

As used herein, the term “monoacetin” is synonymous with glycerol monoacetate, glycerin monoacetate, and glyceryl monoacetate.

As used herein, the term “diacetin” is synonymous with glycerol diacetate; glycerin diacetate, glyceryl diacetate, and all other synonyms of CAS Registry Number 25395-31-7.

As used herein, the term “triacetin” is synonymous with glycerin triacetate; glycerol triacetate; glyceryl triacetate, 1,2,3-triacetoxypropane, 1,2,3-propanetriol triacetate and all other synonyms of CAS Registry Number 102-76-1.

As used herein, the term “monobutyrin” is synonymous with glycerol monobutyrate, glycerin monobutyrate, and glyceryl monobutyrate.

As used herein, the term “dibutyrin” is synonymous with glycerol dibutyrate and glyceryl dibutyrate.

As used herein, the term “tributyrin” is synonymous with glycerol tributyrate, 1,2,3-tributyrylglycerol, and all other synonyms of CAS Registry Number 60-01-5.

As used herein, the term “monopropionin” is synonymous with glycerol monopropionate, glycerin monopropionate, and glyceryl monopropionate.

As used herein, the term “dipropionin” is synonymous with glycerol dipropionate and glyceryl dipropionate.

As used herein, the term “tripropionin” is synonymous with glyceryl tripropionate, glycerol tripropionate, 1,2,3-tripropionylglycerol, and all other synonyms of CAS Registry Number 139-45-7.

As used herein, the term “ethyl acetate” is synonymous with acetic ether, acetoxyethane, ethyl ethanoate, acetic acid ethyl ester, ethanoic acid ethyl ester, ethyl acetic ester and all other synonyms of CAS Registry Number 141-78-6.

As used herein, the term “ethyl lactate” is synonymous with lactic acid ethyl ester and all other synonyms of CAS Registry Number 97-64-3.

As used herein, the term “suitable aqueous reaction conditions” refers to the conditions in which the reactants and enzyme catalyst come into contact. The components and conditions suitable for the reaction are provided herein and those skilled in the art appreciate the range of component and condition variations suitable for these processes.

As used herein, the term “perhydrolysis” is defined as the reaction of a selected substrate with peroxide to form a peracid. Typically, an inorganic peroxide is reacted with the selected substrate in the presence of a catalyst to produce the peracid. As used herein, the term “chemical perhydrolysis” includes perhydrolysis reactions in which a substrate (a peracid precursor) is combined with a source of hydrogen peroxide wherein peracid is formed in the absence of an enzyme catalyst. As used herein, the term “enzymatic perhydrolysis” refers to a perhydrolysis reaction that is assisted or catalyzed by an enzyme.

As used herein, “non-heme haloperoxidase”, “haloperoxidase”, “HPO”, and “bacterial haloperoxidase” refer to a non-heme haloperoxidase that may be further classified as a chloroperoxidase (E.C. 1.11.1.10), bromoperoxidase, or iodoperoxidase (E.C. 1.11.1.8) that catalyzes the halogenation of a variety of substrates in the presence of halide ions and hydrogen peroxide. Non-heme haloperoxidases have been shown to catalyze the peroxidation of acyl carboxylic acids to peracids (U.S. Pat. No. 6,703,540; Jacks et al., supra, 2000; Jacks et al. supra, 2002). As described herein, several non-heme haloperoxidases are provided that exhibit perhydrolysis activity under suitable aqueous reaction conditions towards a variety of carboxylic acid ester substrates.

As used herein, “Psuedomonas putida 5B” refers to the Pseudomonas putida strain deposited with the Northern Regional Research Lab (NRRL) under depository designation NRRL-18668 (U.S. Pat. No. 5,811,286). The Northern Regional Research Lab has been renamed as the National Center for Agriculture, USDA Research (Peoria, Ill.).

As used herein, “Agrobacterium tumefaciens” refers to Agrobacterium tumefaciens strain C58 (Goodner et al., Science, 294(5550):2323-2328 (2001)). This bacterial strain is also referred to as Rhizobium radiobacter and is available from the American Type Culture Collection (ATCC®) under depository designation number ATCC 33970.

As used herein, the term “perhydrolase catalyst” refers herein to an enzyme catalyst (non-heme haloperoxidase) that is characterized by perhydrolysis activity. The enzyme catalyst may be in the form of a whole microbial cell, permeabilized microbial cell(s), one or more cell components of a microbial cell extract, partially purified enzyme, or purified enzyme. As described herein, non-heme haloperoxidases are shown to have perhydrolysis activity towards carboxylic acid esters.

As used herein, the term “perhydrolase activity” refers to the enzyme activity per unit mass (for example, milligram) of protein, dry cell weight, or immobilized catalyst weight. Comparisons of perhydrolase activity of catalysts were determined proportional to the dry cell weight or protein catalyst weight.

As used herein, “one unit of enzyme activity” or “one unit of activity” or “U” is defined as the amount of enzyme activity required for the production of 1 μmol of peracid product per minute at a specified temperature.

As used herein, the term “disinfect” refers to the process of cleansing so as to destroy and prevent the growth of pathogenic microorganisms. As used herein, the term “disinfectant” refers to an agent that disinfects by destroying, neutralizing, or inhibiting the growth of disease-carrying microorganisms and viruses. Typically disinfectants are used to treat inanimate objects or surfaces. As used herein, the term “antiseptic” refers to a chemical agent that inhibits the growth of disease-carrying microorganisms.

As used herein, the terms “virucide” and “viricide” refer to an agent that inhibits or destroys viruses. An agent that exhibits the ability to inhibit or destroy viruses is described as having “virucidal” or “viricidal” activity. Peracids can have virucidal activity. Typical alternative virucides known in the art which may be suitable for use with the present invention include, for example, alcohols, ethers, chloroform, formaldehyde, phenols, beta propiolactone, iodine, chlorine, mercury salts, hydroxylamine, ethylene oxide, ethylene glycol, quaternary ammonium compounds, enzymes, and detergents.

As used herein, the term “biocide” refers to a chemical agent, typically broad spectrum, that inactivates or destroys microorganisms. A chemical agent that exhibits the ability to inactivate or destroy microorganisms is described as having “biocidal” activity. Peracids can have biocidal activity. Typical alternative biocides known in the art, which may be suitable for use in the present invention include, for example, chlorine, chlorine dioxide, chloroisocyanurates, hypochlorites, ozone, acrolein, amines, chlorinated phenolics, copper salts, organo-sulphur compounds, and quaternary ammonium salts.

As used herein, the phrase “minimum biocidal concentration” refers to the minimum concentration of a biocidal agent that, for a specific contact time, will produce a desired lethal, irreversible reduction in the viable population of the targeted microorganisms. The effectiveness can be measured by the log₁₀ reduction in viable microorganisms after treatment. In one aspect, the targeted reduction in viable cells after treatment is a 3-log reduction, more preferably a 4-log reduction, and most preferably at least a 5-log reduction. In another aspect, the minimum biocidal concentration is a 6-log reduction in viable microbial cells.

As used herein, the term “about” modifying the quantity of an ingredient or reactant of the invention employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

Suitable Reaction Conditions for the Enzyme-catalyzed Preparation of Peracids from Carboxylic Acid Esters and Hydrogen Peroxide

In one aspect of the invention, a method is provided to produce an aqueous mixture comprising a peracid by reacting carboxylic acid esters and an inorganic peroxide, not limited to hydrogen peroxide, sodium perborate or sodium percarbonate, in the presence of a non-heme haloperoxidase catalyst having perhydrolysis activity.

Suitable carboxylic acid ester substrates have a formula selected from the group consisting of:
a) esters of the formula 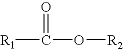
   wherein R₁=C1 to C10 straight chain or branched chain alkyl optionally substituted with an hydroxyl or a C1 to C4 alkoxy group and R₂=C1 to C10 strain chain or branched chain alkyl group, (CH₂CH₂—O)ₙH or (CH₂CH(CH₃)—O)ₙH and n=1 to 10; and
b) glycerides of the formula 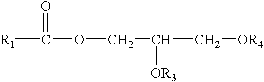
   wherein R₁=C1 to C10 straight chain or branched chain alkyl optionally substituted with an hydroxyl or a C1 to C4 alkoxy group and R₃ and R₄ are individually H or R₁C(O).

In one aspect, the carboxylic acid ester substrates are selected from the group consisting of methyl lactate, ethyl lactate, methyl glycolate, ethyl glycolate, methyl methoxyacetate, ethyl methoxyacetate, methyl 3-hydroxybutyrate, ethyl 3-hydroxybutyrate, triethyl 2-acetyl citrate, glucose pentaacetate, gluconolactone, glycerides (mono-, di-, and triglycerides) such as monoacetin, diacetin (1,2,3-propanetriol diacetate), triacetin (glyceryl triacetate), monopropionin, glyceryl dipropionate, tripropionin (glycercyl tripropionate), monobutyrin, dibutyrin (glyceryl dibutyrate), tributyrin (glyceryl tributyrate), and mixtures thereof.

In another aspect, the carboxylic acid ester substrates are selected from the group consisting of monoacetin, diacetin, triacetin, glyceryl dipropionate, tripropionin, monobutyrin, dibutyrin, tributyrin, ethyl acetate, and ethyl lactate. In yet another aspect, the carboxylic acid ester substrates are selected from the group consisting of diacetin, triacetin, ethyl acetate, and ethyl lactate.

The enzyme substrate (carboxylic acid ester) is present in the reaction mixture at a concentration sufficient to produce the desired concentration of peracid upon enzyme-catalyzed perhydrolysis. It has been demonstrated in the accompanying examples that there are preferred combinations of enzyme substrate and enzyme catalyst that produce a desirable concentration of peracid. The carboxylic acid ester need not be completely soluble in the reaction mixture, but have sufficient solubility to permit conversion of the ester by the enzyme catalyst to the corresponding peracid. The carboxylic acid ester is present in the reaction mixture at a concentration of 0.05 wt % to 40 wt % of the reaction mixture, preferably at a concentration of 0.1 wt % to 20 wt % of the reaction mixture, and more preferably at a concentration of 0.5 wt % to 10 wt % of the reaction mixture.

The peroxygen source may include, but is not limited to, hydrogen peroxide, perborate salts, perphosphate salts, percarbonate salts, and mixtures thereof. The concentration of peroxygen compound in the reaction mixture may range from 0.1 wt % to about 50 wt %, preferably from 1 wt % to about 40 wt %, more preferably from 2 wt % to about 30 wt %.

The enzyme catalysts described herein are members of the non-heme haloperoxidase family (for example, chloroperoxidases [E.C. 1.11.1.10], bromoperoxidases, and iodoperoxidases [E.C. 1.11.1.8]). A catalytic triad (serine 97:aspartic acid 229:histidine 258) has been reported to be responsible for the halogenation activity in this family of proteins (Pelletier et al., Biochimica et Biophysica Acta 1250:149-157 (1995)). The present non-heme haloperoxidases are comprised of this triad, although one of the present non-heme haloperoxidases from Agrobacterium tumefaciens (AtuA2; SEQ ID NO: 18) appears to have a 47 amino acid N-terminal extension. Absent the 47 amino acid N-terminal extension, AtuA2 is comprised of the characteristic triad responsible for halogenation activity. In particular, the enzymes that are useful in the present invention are non-heme haloperoxidases having perhydrolysis activity towards carboxylic acid ester substrates.

In one aspect, the enzyme catalyst is a non-heme haloperoxidase derived or isolated from a prokaryotic organism. In another aspect, the non-heme haloperoxidase is derived or isolated from a bacterium. In another aspect, the non-heme haloperoxidase is derived from an organism selected from the genera consisting of Pseudomonas sp and Agrobacterium sp. In a further aspect, the source of the non-heme haloperoxidase is selected from the group consisting of Pseudomonas putida and Agrobacterium tumefaciens. In a preferred aspect, the source of the non-heme haloperoxidase is selected from the group consisting of Pseudomonas putida 5B (NRRL-1 8668) and Agrobacterium tumefaciens C58 (ATCC 33970).

In one aspect, nucleic acid molecules useful in the present process are those encoding the non-heme haloperoxidases having at least 80% identity to an amino acid sequence selected from the group consisting of SEQ ID NO: 10, 14, 18, 22, and 28. In another aspect, nucleic acid molecules encoding the non-heme haloperoxidase useful in the present process have at least 85% identity, more preferably at least 90%, even more preferably at least 95%, even yet more preferably at least 98%, and most preferably at least 99% to the amino acid sequences reported here. In a further embodiment, the nucleic acid sequences encoding non-heme haloperoxidases useful in the present process are represented by an amino acid sequence selected from the group consisting of SEQ ID NOs: 10, 14, 18, 22, and 28.

In a further embodiment, the nucleic acid sequences encoding non-heme haloperoxidases suitable in the present process have at least 80%, more preferably at least 85%, even more preferably at least 90%, yet even more preferably 95%, even yet more preferably 98%, and more preferably at least 99% nucleic acid sequence identity to the sequences provided herein. In another aspect, nucleic acid sequences encoding non-heme haloperoxidases suitable in the present process have a nucleic acid sequence selected from the group consisting of SEQ ID NOs: 9, 13, 17, 21, and 27.

Many enzyme catalysts (whole cell, partially purified, or purified) have been reported to have catalase activity (EC 1.11.1.6). Catalases catalyze the conversion of hydrogen peroxide into oxygen and water. In one aspect, the perhydrolysis catalyst lacks catalase activity. In another aspect, a catalase inhibitor is added to the reaction mixture. Examples of catalase inhibitors include, but are not limited to, sodium azide and hydroxylamine sulfate. One of skill in the art can adjust the concentration of catalase inhibitor as needed. The concentration of the catalase inhibitor typically ranges from 0.1 mM to about 1 M; preferably about 1 mM to about 50 mM; more preferably from about 1 mM to about 20 mM. In one aspect, sodium azide concentration typically ranges from about 20 mM to about 60 mM while hydroxylamine sulfate concentration is typically about 0.5 mM to about 30 mM, preferably about 10 mM. In a preferred embodiment, the enzyme catalyst lacks significant catalase activity or is engineered to decrease or eliminate catalase activity. Host cells used for recombinant expression of the present perhydrolytic enzymes can be selected that lack catalase activity (for example, E. coli strain UM2 (CGSC 7156)). In a further embodiment, the catalase activity in a host cell can be down-regulated or eliminated by disrupting expression of the gene(s) responsible for the catalase activity using well known techniques including, but not limited to, transposon mutagenesis, RNA antisense expression, targeted mutagenesis, and random mutagenesis.

The concentration of enzyme catalyst in the aqueous reaction mixture is chosen to obtain the desired rate of reaction, and depends on the specific catalytic activity of the enzyme catalyst. The weight of a soluble enzyme used as catalyst in perhydrolysis reactions typically ranges from 0.05 mg to 10 mg of enzyme per mL of total reaction volume, preferably from 0.10 mg to 2.0 mg of enzyme per mL. The enzyme may also be immobilized on a soluble or insoluble support using methods well-known to those skilled in the art; see for example, Immobilization of Enzymes and Cells; Gordon F. Bickerstaff, Editor; Humana Press, Totowa, N.J., USA; 1997. The use of immobilized enzymes permits the recovery and reuse of the catalyst in subsequent reactions. Additional forms of the enzyme catalyst that are useful in the present application include whole microbial cells, cell extracts, and partially-purified enzymes. These additional forms of the catalyst may also be immobilized using the methods referenced above.

In one aspect, the concentration of peracid generated by the combination of chemical perhydrolysis and enzymatic perhydrolysis of the carboxylic acid ester is sufficient to provide an effective concentration of peracid for bleaching or disinfection at a desired pH. In another aspect, the present methods provide combinations of enzymes and enzyme substrates to produce the desired effective concentration of peracid, where, in the absence of added enzyme, there is a significantly-lower concentration of peracid produced. Although there may in some cases be significant chemical perhydrolysis of the enzyme substrate by direct chemical reaction of inorganic peroxide with the enzyme substrate, there may not be a sufficient concentration of peracid generated by chemical perhydrolysis to provide an effective concentration of peracid in the desired applications, and a significant increase in total peracid concentration is achieved by the addition of an appropriate enzyme catalyst to the reaction mixture.

The concentration of peracid generated by enzyme-catalyzed perhydrolysis of carboxylic acid ester is at least 500 ppb peracid, preferably at least 1 ppm peracid, more preferably at least 2 ppm peracid, even more preferably at least 4 ppm peracid, even yet more preferably at least 5 ppm, and most preferably at least 8 ppm. The product mixture comprising the peracid may be optionally diluted with water, or a solution predominantly comprised of water, to produce a mixture with the desired lower concentration of peracid. The reaction time required to produce the desired concentration of peracid is not greater than about two hours, preferably not greater than about 30 minutes, more preferably not greater than about 10 minutes, and most preferably less than about 5 minutes. The peracid concentration may continue to increase above the initial desired concentration of peracid generated in not greater than about 2 hours, such that the reaction mixture produces a maximum concentration of peracid in at least 48 hours.

The temperature of the reaction is chosen to control both the reaction rate and the stability of the enzyme catalyst activity. The temperature of the reaction may range from just above the freezing point of the reaction mixture (approximately 0° C.) to about 65° C., with a preferred range of reaction temperature of from about 5° C. to about 35° C.

The pH of the final reaction mixture containing peracid is from about 1 to about 10, preferably from about 2 to about 7.5, more preferably from about 3 to about 7, and most preferably about 3.5 to about 6.5. The pH of the reaction, and of the final reaction mixture, may be controlled by the addition of a suitable buffer, including, but not limited to phosphate, pyrophosphate, bicarbonate, acetate, or citrate. The concentration of buffer is from 0.1 mM to 1.0 M, preferably from 1 mM to 100 mM, most preferably from 10 mM to 50 mM.

In another aspect, the enzymatic perhydrolysis product may contain additional components that provide desirable functionality. In one aspect, the desirable functionality may include use of the present materials in bleaching applications. These additional components include, but are not limited to emulsifiers and surfactants. Examples of emulsifiers include polyvinyl alcohol or polyvinylpyrrolidine. Examples of surfactants, including a) non-ionic surfactants such as block copolymers of ethylene oxide or propylene oxide, ethoxylated or propoxylated linear and branched primary and secondary alcohols, and aliphatic phosphine oxides b) cationic surfactants such as such as quaternary ammonium compounds, particularly quaternary ammonium compounds having a C8-C20 alkyl group bound to a nitrogen atom additionally bound to three C1-C2 alkyl groups, c) anionic surfactants such as alkane carboxylic acids (e.g., C8-C20 fatty acids), alkyl phosphonates, alkane sulfonates (e.g., sodium dodecylsulphate) or linear or branched alkyl benzene sulfonates, alkene sulfonates and d) amphoteric and zwitterionic surfactants such as aminocarboxylic acids, aminodicarboxylic acids, and alkybetaines. Additional components may include fragrances, dyes, stabilizers of hydrogen peroxide (e.g., 1-hydroxyethylidene -1,1,-diphosphonic acid (Dequest 2010, Solutia Inc., St. Louis, Mo.)), stabilizers of enzyme activity (e.g., polyethyleneglycol (PEG)), detergent builders and metal chelators (e.g., ethylenediaminetetraacetic acid (EDTA)).

Enzymatic In Situ Production of Peracids

The present aqueous enzymatic method produces useful concentrations of peracids for biocidal and/or virucidal applications in situ. The peracids produced are quite reactive and unstable, generally decreasing in concentration over time. As such, it may be desirable to keep the various reaction components separated, especially for formulations where at least one component of the formulation is a liquid. In one aspect, the hydrogen peroxide source is separate from either the substrate or the enzyme, preferably from both. This can be accomplished using a variety of techniques including, but not limited to the use of multicompartment chambered dispensers (U.S. Pat. No. 4,585,150) and subsequently physically combining the enzyme catalyst with the present substrates to initiate the aqueous enzymatic perhydrolysis reaction. The enzyme catalyst may be immobilized within the body of reaction chamber or separated (e.g. filtered, etc.) from the reaction product comprising the peracid prior to contacting the surface and/or object targeted for treatment. The enzyme catalyst may be in a liquid matrix or in a solid form (i.e. powdered, tablet) or embedded within a solid matrix that is subsequently mixed with the substrates to initiate the enzymatic perhydrolysis reaction. In a further aspect, the enzyme catalyst may be contained within a dissolvable or porous pouch that may be added to the aqueous substrate matrix to initiate enzymatic perhydrolysis.

HPLC Assay Method for Determining the Concentration of Peracid and Hydrogen Peroxide.

A variety of analytical methods can be used in the present method to analyze the reactants and products including, but not limited to titration, high performance liquid chromatography (HPLC), gas chromatography (GC), mass spectroscopy (MS), capillary electrophoresis (CE), the analytical procedure described by U. Karst et al., (Anal. Chem., 69(17):3623-3627 (1997)), and the 2,2′-azino-bis (3-ethylbenzothazoline)-6-sulfonate (ABTS) assay (S. Minning, et al., Analytica Chimica Acta 378:293-298 (1999) and WO 2004/058961 A1) as described in the present examples.

Determination of Minimum Biocidal Concentration of Peracids

The method described by J. Gabrielson, et al. (J. Microbiol. Methods 50: 63-73 (2002)) can be employed for determination of the Minimum Biocidal Concentration (MBC) of peracids, or of hydrogen peroxide and enzyme substrates. The assay method is based on XTT reduction inhibition, where XTT ((2,3-bis[2-methoxy-4-nitro-5-sulfophenyl]-5-[(phenylamino)carbonyl]-2H-tetrazolium, inner salt, monosodium salt) is a redox dye that indicates microbial respiratory activity by a change in optical density (OD) measured at 490 nm or 450 nm. However, there are a variety of other methods available for testing the activity of disinfectants and antiseptics including, but not limited to viable plate counts, direct microscopic counts, dry weight, turbidity measurements, absorbance, and bioluminescence (see, for example Brock, Semour S., Disinfection, Sterilization, and Preservation, 5^{th} edition, Lippincoft Williams & Wilkins, Philadelphia, Pa., USA; 2001).

Uses of Enzymatically-Prepared Peracid Compositions

The enzyme-generated peracid produced according to the present methods can be used in a variety of applications for reduction of microbial, fungal, and viral contamination, such as decontamination of medical instruments (e.g., endoscopes), textiles (e.g., garments, carpets), food preparation surfaces, food storage and food-packaging equipment, materials used for the packaging of food products, chicken hatcheries and grow-out facilities, animal enclosures, and spent process waters that have microbial and/or virucidal activity. The enzyme-generated peracids may be used in formulations designed to inactivate prions (e.g. formulations containing certain proteases) to additionally provide biocidal activity. In a preferred aspect, the present peracid compositions are particularly useful as a cleaning and disinfecting agent for non-autoclavable medical instruments and food packaging equipment. As the peracid-containing formulation may be prepared using GRAS or food-grade components (enzyme, enzyme substrate, hydrogen peroxide, and buffer), the enzyme-generated peracid may also be used for decontamination of animal carcasses, meat, fruits and vegetables, or for decontamination of prepared foods. The enzyme-generated peracid may be incorporated into a product whose final form is a powder, liquid, gel, solid or aerosol. The enzyme-generated peracid may be diluted to a concentration that still provides an efficacious decontamination.

The compositions comprising an efficacious concentration of peracid can be used to clean and disinfect surfaces and/or objects contaminated (or suspected of being contaminated) with pathogenic microorganisms and/or viruses by contacting the surface or object with the products produced by the present processes. As used herein, “contacting” refers to placing a disinfecting composition comprising an effective concentration of peracid in contact with the surface or inanimate object suspected of contamination with a disease-causing entity for a period of time sufficient to clean and disinfect. Contacting includes spraying, treating, immersing, flushing, pouring on or in, mixing, combining, painting, coating, applying, affixing to and otherwise communicating a peracid solution comprising an efficacious concentration of peracid with the surface or inanimate object suspected of being contaminated. The compositions comprising an efficacious concentration of peracid can also contain an additional antimicrobial agent, virucide or biocide. Combinations of these agents with the peracid produced by the claimed processes can provide for increased and/or synergistic effects when used to clean and disinfect surfaces and/or objects contaminated (or suspected of being contaminated) with pathogenic microorganisms, viruses, and/or prions. Suitable antimicrobial agents include carboxylic esters (e.g., p-hydroxy alkyl benzoates and alkyl cinnamates), sulfonic acids (e.g., dodecylbenzene sulfonic acid), iodo-compounds or active halogen compounds (e.g., elemental halogens, halogen oxides (e.g., NaOCl, HOCl, HOBr, ClO₂), iodine, interhalides (e.g., iodine monochloride, iodine dichloride, iodine trichloride, iodine tetrachloride, bromine chloride, iodine monobromide, or iodine dibromide), polyhalides, hypochlorite salts, hypochlorous acid, hypobromite salts, hypobromous acid, chloro- and bromo-hydantoins, chlorine dioxide, and sodium chlorite), organic peroxides including benzoyl peroxide, alkyl benzoyl peroxides, ozone, singlet oxygen generators, and mixtures thereof, phenolic derivatives (e.g., o-phenyl phenol, o-benzyl-p-chlorophenol, tert-amyl phenol and C₁-C₆ alkyl hydroxy benzoates), quaternary ammonium compounds (e.g., alkyldimethylbenzyl ammonium chloride, dialkyldimethyl ammonium chloride and mixtures thereof), and mixtures of such antimicrobial agents, in an amount sufficient to provide the desired degree of microbial protection. Effective amounts of antimicrobial agents include about 0.001 wt-% to about 60 wt-% antimicrobial agent, about 0.01 wt-% to about 15 wt-% antimicrobial agent, or about 0.08 wt-% to about 2.5 wt-% antimicrobial agent.

Applicants specifically incorporate the entire contents of all cited references in this disclosure. Further, when an amount, concentration, or other value or parameter is given either as a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

### General Methods

The following examples are provided to demonstrate preferred aspects of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

PCR Parameters:

Methods to synthesize nucleic acid molecules using PCR amplification are well known in the art. PCR reagents were obtained from Roche Diagnostics Corporation (Indianapolis, Ind.) and used as recommended by the manufacturer's instructions.

PCR cycle parameters were are follows:

Step 1: 5 minutes at 95° C.
Step 2: 0.5 minutes at 95° C. (denaturation)
Step 3: 0.5 minutes at 55° C. (annealing)
Step 4: 1 minutes at 74° C. (extension)
Steps 2-4 are repeated 25 cycles

All reagents and materials were obtained from DIFCO Laboratories (Detroit, Mich.), GIBCO/BRL (Gaithersburg, Md.), TCI America (Portland, Oreg.), Roche Diagnostics Corporation (Indianapolis, Ind.) or Sigma/Aldrich Chemical Company (St. Louis, Mo.), unless otherwise specified.

The following abbreviations in the specification correspond to units of measure, techniques, properties, or compounds as follows: “sec” or “s” means second(s), “min” means minute(s), “h” or “hr” means hour(s), “d” means density in g/mL, “μL” means microliters, “mL” means milliliters, “L” means liters, “mM” means millimolar, “M” means molar, “mmol” means millimole(s), “ppm” means parts per million, “ppb” means parts per billion, “wt” means weight, “wt %” means weight percent, “g” means grams, “μg” means micrograms, HPLC” means high performance liquid chromatography, “O.D.” means optical density at the designated wavelength, “dcw” means dry cell weight, “CFU” means colony forming units, “ATCC” or “ATCC®” means the American Type Culture Collection, “U” means units of perhydrolase activity, “RPM” means revolutions per minute, “EDTA” means ethylenediaminetetraacetic acid, “IPTG” means isopropyl β-D-1-thiogalactopyranoside, “CFU” means colony forming units, “XTT” means ((2,3-Bis-[2-methoxy-4-nitro-5-sulfophenyl]-2H-tetrazolium-5-carboxanilide inner salt; CAS# 111072-31-2), and “CGSC” means Coli Genetic Stock Center (Yale University Escherichia Coli Genetic Stock Center, New Haven, Conn.).

### EXAMPLE 1

### Cloning of P. putida 5B non-heme haloperoxidase

A series of PCR primers were designed based on published non-heme haloperoxidase sequences from P. putida strains, including KT2440, IF-3, and MR-2068 (GenBank® 26991929, 6451702, and 1360922; respectively). PCR using the genomic DNA from P. putida 5B (NRRL-18668) with primer#1 (5-GATCTGGTCATCGTCGCCATGCATCAC-3′; SEQ ID NO: 1) and primer#2 (5′-GCCGACGACTGGGACGCGCAGATG-3′; SEQ ID NO: 2) and with primer#1 and primer#3 (5′-ATGAGCTACGTCACCACCAAAGATGG-3′; SEQ ID NO: 3) produced products of approximately 600 bp and 700 bp, respectively. Nucleotide sequences of these products (SEQ ID NOs: 4 and 5) and the corresponding deduced amino acid sequences confirmed the identity of a partial non-heme haloperoxidase gene. Genomic sequencing with primer#4 (5′-GGCTACGTCGTCGGCATAGTGGTC-3′; SEQ ID NO: 6) revealed the presence of a PstI restriction site several hundred bp upstream of the non-heme haloperoxidase gene. Genomic DNA was digested with PstI followed by ligation, and inverse PCR was performed using primer#5 (5′-GGTGGAAGTGGATCACCGGTGCATCGC-3′; SEQ ID NO: 7) and primer#6 (5′-GCCCATTACGATGGCATCGTGGC-3′; SEQ ID NO: 8). Nucleotide sequence obtained from this PCR product was used to elucidate the entire native Psuedomonas putida 5B non-heme haloperoxidase coding sequence (SEQ ID NO: 9) encoding the amino acid represented by SEQ ID NO: 10.

### EXAMPLE 2

### Expression of P. putida 5B non-heme haloperoxidase in E. coli

The non-heme haloperoxidase gene from P. putida 5B was PCR amplified using primer#7 (5′-GAATTCATGAGCTATGTAACCACGMGGACGGC-3′; SEQ ID NO: 11) and primer#8 (5′-GCGGCCGCTTMCTACGGATAAACGCCAGCAAATCCGCAT-3′; SEQ ID NO: 12), and subcloned into pTrcHis2-TOPO® (Invitrogen) and into pCR®4-TOPO® (Invitrogen) to generate the expression plasmids pSW167 and pSW169, respectively. In addition, the EcoRI fragment from pSW169 was subcloned into pET-28a (Novagen; Madison, Wis.) to generate the expression plasmid pSW174. E. coli TOP10 (Invitrogen) was transformed with pSW167 or pSW169 to generate the strains TOP10/pSW167 and TOP10/pSW169, respectively. E. coli BL21 (DE3) (Novagen) was transformed with pSW174 to generate the strain BL21/pSW174. The 5B non-heme haloperoxidase was expressed in TOP10/pSW167, TOP10/pSW169, and BL21/pSW174 according to Invitrogen's expression protocol. Essentially, cells were induced at OD₆₀₀=0.5-0.6 with 1 mM IPTG for 3 hr at 37° C. with shaking. SDS-PAGE analysis confirmed production of a protein with molecular weight of approximately 30 kDa, a band not present in the control strain (host without plasmid). Also transformed with pSW167 and with pSW169 were E. coli FM5 (ATCC 53911) and E. coli UM2 (CGSC 7156) to generate the strains FM5/pSW167, UM2/pSW167, FM5/pSW169, and UM2/pSW169.

### EXAMPLE 3

Expression of A. tumefaciens non-heme haloperoxidase (GenBank® 16119616) in E. coli

The non-heme haloperoxidase gene (GenBank® 16119616; herein also referred to as “AtuA1”; SEQ ID NOs: 13-14) from A. tumefaciens C58 (“C58”) was PCR-amplified using primer#9 (5′-ATGGGCTTCGTMCMCCAAGGACGGCAC-3′; SEQ ID NO: 15) and primer#10 (5′-TCAGCCCTTGATGAAGGCTAGCAGGTCCTG-3′; SEQ ID NO: 16), and subcloned into pCR®4-TOPO® (invitrogen) to generate the plasmid pSW166. In addition, the EcoRI fragment from pSW166 was subcloned into pET-28a (Novagen) to generate the expression plasmid pSW175. E. coli TOP10 (Invitrogen) was transformed with pSW166 to generate the strain TOP10/pSW166. E. coli BL21 (DE3) (Novagen) was transformed with pSW175 to generate the strain BL21/pSW175. The C58 non-heme haloperoxidase was expressed in TOP10/pSW166 and BL21/pSW175 by inducing at OD₆₀₀=0.5-0.6 with 1 mM IPTG for 3 hr at 37° C. with shaking. SDS-PAGE analysis confirmed production of a protein with molecular weight of approximately 30 kDa, a protein not present in the control strains (cells without plasmid). Also transformed with pSW166 were E. coli FM5 (ATCC 53911) and E. coli UM2 (CGSC 7156) to generate the strains FM5/pSW166 and UM2/pSW166.

### EXAMPLE 4

### Expression of A. tumefaciens non-heme haloperoxidase (GenBank(® 16119293) in E. coli

The non-heme haloperoxidase gene (GenBank® 16119293; herein also referred to “AtuA2”; SEQ ID NOs: 17-18) from A. tumefaciens C58 was PCR-amplified using primer#11 (5′-ATGTCGCGTTTCACCACCACTGACGGTACC-3′; SEQ ID NO: 19 and primer#12 (5′-TCAGCCGTGGATAAAGGCGAGCACGTCG-3′; SEQ ID NO: 20, and subcloned into pCR®4-TOPO® (Invitrogen) and into pTrcHis2-TOPO® (Invitrogen) to generate the expression plasmids pSW171 and pSW173, respectively. In addition, the EcoRI fragment from pSW171 was subcloned into pET-28a (Novagen) to generate the expression plasmid pSW176. E. coli TOP10 (Invitrogen) was transformed with pSW171 or pSW173 to generate the strains TOP10/pSW171 and TOP10/pSW173, respectively. E. coli BL21 (DE3) (Novagen) was transformed with pSW176 to generate the strain BL21/pSW176. The C58 non-heme haloperoxidase was expressed in TOP10/pSW171, TOP10/pSW173, and BL21/pSW176 by inducing at OD₆₀₀=0.5-0.6 with 1 mM IPTG for 3 hr at 37° C. with shaking. SDS-PAGE analysis confirmed production of a protein with molecular weight of approximately 30 kDa, a protein not present in the control strains (host cells without plasmid). Also transformed with pSW171 and pSW173 were E. coli FM5 (ATCC 53911) and E. coli UM2 (CGSC 7156) to generate the strains FM5/pSW171, UM2/pSW171 FM5/pSW173, and UM2/pSW173.

### EXAMPLE 5

### Expression of A. tumefaciens non-heme haloperoxidase (GenBank® 15891475) in E. coli

The non-heme haloperoxidase gene (GenBank® 15891475; herein also referred to “AtuA3”; SEQ ID NOs: 21-22) from A. tumefaciens C58 was PCR-amplified using primer#13 (5′-ATGACAACGATCACCACCAGAGACGGMCG-3′; SEQ ID NO: 23) and primer#14 (5′-TCAGGCGTTGATGMGGTGAGGAGGTCG-3′; SEQ ID NO: 24), and subcloned into pTrcHis2-TOPO® (Invitrogen) to generate the plasmid pSW170. In addition, the non-heme haloperoxidase gene (GenBank® 15891475) from A. tumefaciens C58 was PCR amplified using primer#15 (5′-CMTTGATGACMCGATCACCACCAGAGACG-3′; SEQ ID NO: 25) and primter#16 (5′-CAATTGCGGCCGCTTAGGCGTTGATGAAGGTGAGGAGGTCGGC-3′; SEQ ID NO: 26), and subcloned into pET-28a (Novagen) between MfeI and NotI to generate the expression plasmid pSW177. E. coli TOP10 (Invitrogen) was transformed with pSW170 to generate the strain TOP10/pSW170. The C58 non-heme haloperoxidase was expressed in TOP10/pSW170 and BL21/pSW177 by inducing at OD₆₀₀=0.5-0.6 with 1 mM IPTG for 3 hr at 37° C. with shaking. SDS-PAGE analysis confirmed production of a protein with molecular weight of approximately 30 kDa, a protein not present in the control strains (host cells without plasmid). Also transformed with pSW170 were E. coli FM5 (ATCC 53911) and E. coli UM2 (CGSC 7156) to generate the strains FM5/pSW170and UM2/pSW170.

### EXAMPLE 6

### Expression of A. tumefaciens non-heme haloperoxidase (GenBank® 15891444) in E. coli

The non-heme haloperoxidase gene (GenBank® 15891444; herein also referred to “AtuA4”; SEQ ID NOs: 27-28) from A. tumefaciens C58 was PCR-amplified using primer#17 (5-ATGGGCTTTGTTAAGACGACAGACGGMCC-3′; SEQ ID NO: 29 and primer#18 (5′-TCAGCCCTTGATGMGGCCAGCAGATCC-3′; SEQ ID NO: 30, and subcloned into pTrcHis2-TOPO® (Invitrogen) to generate the plasmid pSW172. In addition, the non-heme haloperoxidase gene (GenBank® 15891444) from A. tumefaciens C58 (C58) was PCR amplified using primer#19 (5-ATGAATTCATGGGCTTTGTTAAGACGACAGACG-3′; SEQ ID NO: 31) and primer#20 (5′-ATGCGGCCGCTCAGCCCTTGATGMGGCCAGCAGATC-3′; SEQ ID NO: 32), and subcloned into pET-28a (Novagen) to generate the expression plasmid pSW178. E. coli TOP10 (Invitrogen) was transformed with pSW172 to generate the strain TOP10/pSW172. E. coli BL21 (DE3) (Novagen) was transformed with pSW178 to generate the strain BL21/pSW178. The C58 non-heme haloperoxidase was expressed in TOP10/pSW172 and BL21/pSW178 by inducing at OD₆₀₀=0.5-0.6 with 1 mM IPTG for 3 hr at 37° C. with shaking. SDS-PAGE analysis confirmed production of a protein with molecular weight of approximately 30 kDa, a protein not present in the control strains (host cells without plasmid). Also transformed with pSW172 were E. coli FM5 (ATCC 53911) and E. coli UM2 (CGSC 7156) to generate the strains FM5/pSW172 and UM2/pSW172.

### EXAMPLE 7

### Preparation of Cell Paste

A single colony from a LB plate containing either ampicillin (E. coli TOP10) or kanamycin (E. coli BL21) was transferred to 2 mL of Miller's LB broth containing 50 μg/mL ampicillin or kanamycin and grown for 16-18 hours at 37° C. with shaking (250 rpm). 50 mL of Miller's LB containing the appropriate antibiotic was inoculated with 0.5 mL of 18 hr culture. Cells were grown at 37° C. with shaking (250 rpm) until an optical density (OD₆₀₀) of 0.5 was reached. A 1M solution of IPTG was added to a final concentration of 1 mM and growth continued for 3 hours. Cells were harvested by centrifugation at 7,000 rpm for 20 minutes. Wet cell weight was determined and cell pellet was frozen and stored at −70° C. This method may be scaled to 500 mL.

Non-recombinant cell lines (E. coli and Pseudomonas putida 5B (NRRL-18668)) were transferred from a single colony on LB agar with no antibiotics to 50 mL of Miller's LB. Growth was at 37° C. with shaking (250 rpm) for 8-18 hours. Harvest conditions were the same as for recombinant cells.

### EXAMPLE 8

### Peracid Production and Detection Assay at pH 6.5

This example describes a method that combines the production of peracid and the measurement of the amount of peracid produced. The assay was carried out in 96-well microtiter plates and analyzed using a SpectroMax® Plus (Molecular Devices Corp.; Sunnyvale, Calif.) plate reader at 405 nm.

Oxidation of 2,2′-azino-bis-(3-ethylbenzothiazoline)-6-sulfonate (ABTS) was used to measure peracid concentration. Briefly, the enzyme catalyst was mixed with the substrate in the presence of hydrogen peroxide to produce the peracid. The amount of peracid produced was determined by mixing the peracid with ABTS. The concentration of the oxidized ABTS was measured spectrophotometrically at 405 nm in microtiter plates.

Whole cell paste was suspended in 0.1M KH₂PO₄ buffer (pH 6.5) at a final concentration of 50 mg/mL wet cell weight. A mixture of 100 μL of cell suspension, 30 μL of 0.1 M phosphate buffer (pH 6.5), 20 μL of 313 mM hydrogen peroxide and 50 μL of 200 mM substrate were incubated at 37° C. for 15 minutes to 24 hr. Control samples were prepared by omitting hydrogen peroxide from the reaction mixture, and substituting an equivalent volume of deionized water. The reaction mixture was assayed by mixing 100 μL of the supernatant from a centrifuged reaction mixture with 50 μL of 1.5 M acetic acid containing 0.03 mg/mL potassium iodide and 50 μL of 1 mg/mL 2,2′-azino-bis-(3-ethylbenzothiazoline)-6-sulfonate (ABTS) in a microtiter plate well, incubating at room temperature for 10 minutes, and measuring the absorbance of the assay mixture at 405 nm.

### EXAMPLE 9

### Peracid Production and Detection Assay at pH 4.0

This example describes a method that combines the production of peracid and the measurement of the amount of peracid produced. The assay was carried out in 96-well microtiter plates and analyzed using a SpectroMax® Plus plate reader at 405 nm.

Whole cell paste was suspended in 0.1 M sodium acetate buffer (pH 4.0) at a final concentration of 50 mg/mL wet cell weight. A mixture of 100 μL of cell suspension, 30 μL of 0.1 M acetate buffer (pH 4.0), 20 μL of 313 mM hydrogen peroxide and 50 μL of 200 mM substrate were incubated at 37° C. for 15 minutes to 24 hours. Control samples were prepared by omitting hydrogen peroxide from the reaction mixture, and substituting an equivalent volume of deionized water. The reaction mixture was assayed by mixing 100 μL of the supernatant from a centrifuged reaction mixture with 50 μL of 1.5 M acetic acid containing 0.03 mg/mL potassium iodide and 50 μL of 1 mg/mL 2,2′-azino-bis-(3-ethylbenzothiazoline)-6-sulfonate (ABTS) in a microtiter plate well, incubating at room temperature for 10 minutes, and measuring the absorbance of the assay mixture at 405 nm.

### EXAMPLE 10

### Production of Peracetic Acid by Perhydrolysis of Triacetin with Hydrogen Peroxide Using E. coli Non-heme Haloperoxidase Transformants (pH 6.5)

Following the method for analysis of peracid production described in Example 8, the following E. coli transformants were assayed for perhydrolysis activity using triacetin and hydrogen peroxide. Due to the presence of catalase in these clones, it was necessary to add sodium azide (50 mM) as an inhibitor of catalase to the reaction mixture. Samples were analyzed approximately 24 hours after the reaction was initiated (Table 1). Controls for each transformant were performed by omitting the addition of H₂O₂, and all controls produced 0 ppm peracid.

TABLE 1

| | Peracetic acid in |
|---|---|
| E. coli | ppm |
| Cell/Plasmid ID | using triacetin |
| TOP10/pSW167 | 3.8 |
| (Ppu5B) | |
| TOP10/pSW169 | 8.4 |
| (Ppu5B) | |
| TOP10/pSW166 | 0.9 |
| (AtuA1) | |
| TOP10/pSW173 | 6.4 |
| (AtuA2) | |
| TOP10/pSW171 | 7.2 |
| (AtuA2) | |
| TOP10/pSW170 | 0.8 |
| (AtuA3) | |
| TOP10/pSW172 | 1.2 |
| (AtuA4) | |
| BL21/pSW174 | 4.6 |
| (Ppu5B) | |
| BL21/pSW175 | 4.6 |
| (AtuA1) | |
| BL21/pSW176 | 10 |
| (AtuA2) | |
| BL21/pSW177 | 6 |
| (AtuA3) | |
| BL21/pSW178 | 4 |
| (AtuA4) | |
| Control (no H₂O₂) | 0 |

### EXAMPLE 11

### Production of Peracetic Acid by Perhydrolysis of Ethyl Acetate with Hydrogen Peroxide Using E. coli Non-heme Haloperoxidase Transformants (pH 6.5)

Following the method for analysis of peracid production described in Example 8, the following E. coli transformants were assayed for perhydrolysis activity using ethyl acetate and hydrogen peroxide. Due to the presence of catalase in these clones, it was necessary to add sodium azide (50 mM) as an inhibitor of catalase to the reaction mixture. Samples were analyzed approximately 24 hours after the reaction was initiated (Table 2). Controls for each transformant were performed by omitting the addition of H₂O₂, and all controls produced 0 ppm peracid.

TABLE 2

| E. coli | Peracetic acid |
|---|---|
| Cell/Plasmid ID | (ppm) |
| TOP10/pSW167 | 5.4 |
| (Ppu5B) | |
| TOP10/pSW169 | 0.8 |
| (Ppu5B) | |
| TOP10/pSW166 | 0 |
| (AtuA1) | |
| TOP10/pSW173 | 0 |
| (AtuA2 | |
| TOP10/pSW171 | 0 |
| (AtuA2) | |
| TOP10/pSW170 | 1.0 |
| (AtuA3) | |
| TOP10/pSW172 | 0.8 |
| (AtuA4) | |
| BL21/pSW174 | 5.6 |
| (Ppu5B) | |
| BL21/pSW175 | 1 |
| (AtuA1) | |
| BL21/pSW176 | 0 |
| (AtuA2) | |
| BL21/pSW177 | 0 |
| (AtuA3) | |
| BL21/pSW178 | 2 |
| (AtuA4) | |
| Control (no H₂O₂) | 0 |

### EXAMPLE 12

### Production of Peracetic Acid by Perhydrolysis of Triacetin with Hydrogen Peroxide Using E. coli Non-heme Haloperoxidase Transformants (pH 6.5)

Following the method for analysis of peracid production described in Example 8, the following E. coli transformants were assayed for perhydrolysis activity using triacetin and hydrogen peroxide. The E. coli host UM2 is catalase negative, and no catalase inhibitor was added to the reactions. Samples were analyzed approximately 30 min after the reaction was initiated (Table 3). Controls for each transformant were performed by omitting the addition of H₂O₂, and all controls produced 0 ppm peracid.

TABLE 3

| E. coli | Peracetic acid |
|---|---|
| Cell/Plasmid ID | (ppm) |
| UM2/pSW166 | 4.3 |
| (AtuA1) | |
| UM2/pSW167 | 2.3 |
| (Ppu5B) | |
| Control (no H₂O₂) | 0 |

### EXAMPLE 13

### Production of Peracetic Acid by Perhydrolysis of Ethyl Acetate with Hydrogen Peroxide Using E. coli Non-heme Haloperoxidase Transformants (pH 6.5)

Following the method for analysis of peracid production described in Example 8, the following E. coli transformants were assayed for perhydrolysis activity using ethyl acetate and hydrogen peroxide. The E. coli host UM2 is catalase negative, and no catalase inhibitor was added to the reactions. Samples were analyzed approximately 30 min after the reaction was initiated (Table 4). Controls for each transformant were performed by omitting the addition of H₂O₂, and all controls produced 0 ppm peracid.

TABLE 4

| E. coli | Peracetic acid |
|---|---|
| Cell/Plasmid ID | (ppm) |
| UM2/pSW166 | 0.78 |
| (AtuA1) | |
| UM2/pSW167 | 3.6 |
| (Ppu5B) | |
| Control (no H₂O₂) | 0 |

### EXAMPLE 14

### Production of Perlactic Acid by Perhydrolysis of Ethyl Lactate with Hydrogen Peroxide Using E. coli Non-heme Haloperoxidase Transformants (pH 6.5)

Following the method for analysis of peracid production described in Example 8, the following E. coli transformants were assayed for perhydrolysis activity using ethyl lactate and hydrogen peroxide. The E. coli host UM2 is catalase negative, and no catalase inhibitor was added to the reactions. Samples were analyzed approximately 30 min after the reaction was initiated (Table 5). Controls for each transformant were performed by omitting the addition of H₂O₂, and all controls produced 0 ppm peracid.

TABLE 5

| E. coli | Perlactic acid |
|---|---|
| Cell/Plasmid ID | (ppm) |
| UM2/pSW166 | 0.78 |
| (AtuA1) | |
| UM2/pSW167 | 3.0 |
| (Ppu5B) | |
| Control (no H₂O₂) | 0 |

### EXAMPLE 15

### Production of Peracetic Acid by Perhydrolysis of Triacetin with Hydrogen Peroxide Using E. coli Non-heme Haloperoxidase Transformants (pH 4.0)

Following the method for analysis of peracid production described in Example 9, the following E. coli transformants were assayed for perhydrolysis activity using triacetin and hydrogen peroxide. The E. coli host UM2 is catalase negative, and no catalase inhibitor was added to the reactions. Samples were analyzed approximately 30 min after the reaction was initiated (Table 6). Controls for each transformant were performed by omitting the addition of H₂O₂, and all controls produced 0 ppm peracid.

TABLE 6

| E. coli | Peracetic acid |
|---|---|
| Cell/Plasmid ID | (ppm) |
| UM2/pSW166 | 1.6 |
| (AtuA1) | |
| UM2/pSW167 | 0.75 |
| (Ppu5B) | |
| Control (no H₂O₂) | 0 |

### EXAMPLE 16

### Production of Peracetic Acid by Perhydrolysis of Ethyl Acetate with Hydrogen Peroxide Using E. coli Non-heme Haloperoxidase Transformants (pH 4.0)

Following the method for analysis of peracid production described in Example 9, the following E. coli transformants were assayed for perhydrolysis activity using ethyl acetate and hydrogen peroxide. The E. coli host UM2 is catalase negative, and no catalase inhibitor was added to the reactions. Samples were analyzed approximately 30 min after the reaction was initiated (Table 7). Controls for each transformant were performed by omitting the addition of H₂O₂, and all controls produced 0 ppm peracid.

TABLE 7

| E. coli | Peracetic acid |
|---|---|
| Cell/Plasmid ID | (ppm) |
| UM2/pSW166 | 1.3 |
| (AtuA1) | |
| UM2/pSW167 | 0.66 |
| (Ppu5B) | |
| Control (no H₂O₂) | 0 |

### EXAMPLE 17

### Production of Perlactic Acid by Perhydrolysis of Ethyl Lactate with Hydrogen Peroxide Using E. coli Non-heme Haloperoxidase Transformants (pH 4.0)

Following the method for analysis of peracid production described in Example 9, the following E. coli transformants were assayed for perhydrolysis activity using ethyl lactate and hydrogen peroxide. The E. coli host UM2 is catalase negative, and no catalase inhibitor was added to the reactions. Samples were analyzed approximately 30 min after the reaction was initiated (Table 8). Controls for each transformant were performed by omitting the additional of H₂O₂, and all controls produced 0 ppm peracid.

TABLE 8

| E. coli | Perlactic acid |
|---|---|
| Cell/Plasmid ID | (ppm) |
| UM2/pSW166 | 1.5 |
| (AtuA1) | |
| UM2/pSW167 | 0.68 |
| (Ppu5B) | |
| Control (no H₂O₂) | 0 |

### EXAMPLE 18

### Production of Peracetic Acid by Perhydrolysis of Triacetin with Hydrogen Peroxide Using Pseudomonas putida 5B Non-heme Haloperoxidase (pH 6.5)

Following the method for analysis of peracid production described in Example 8, P. putida 5B was assayed for perhydrolysis activity using triacetin and hydrogen peroxide. Approximately 10 mM hydroxylamine sulfate was used as inhibitor of catalase activity in the reaction mixture. The sample was analyzed approximately 30 min after the reaction was initiated, and 3.7 ppm peracetic acid was produced.

### EXAMPLE 19

### Production of Peracetic Acid by Perhydrolysis of Ethyl Acetate with Hydrogen Peroxide Using Pseudomonas putida 5B Non-heme Haloperoxidase (pH 6.5)

Following the method for analysis of peracid production described in Example 8, P. putida 5B was assayed for perhydrolysis activity using ethyl acetate and hydrogen peroxide. Approximately 10 mM hydroxylamine sulfate was used as inhibitor of catalase activity in the reaction mixture. The sample was analyzed approximately 30 min after the reaction was initiated, and 2.0 ppm peracetic acid was produced.

### EXAMPLE 20

### Production of Perlactic Acid by Perhydrolysis of Ethyl Lactate with Hydrogen Peroxide Using Pseudomonas putida 5B Non-heme Haloperoxidase (pH 6.5)

Following the method for analysis of peracid production described in Example 8, P. putida 5B was assayed for perhydrolysis activity using ethyl lactate and hydrogen peroxide. Approximately 10 mM hydroxylamine sulfate was used as inhibitor of catalase activity in the reaction mixture. The sample was analyzed approximately 30 min after the reaction was initiated, and 3.2 ppm perlactic acid was produced

What is claimed is:

1. A process for producing peracids from carboxylic acid ester substrates comprising
a) providing a set of peracid reaction components, said components comprising:
1) a carboxylic acid ester substrate selected from the group consisting of:
i) esters having the structure 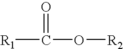
wherein R₁=C1 to C10 straight chain or branched chain alkyl optionally substituted with an hydroxyl or a C1 to C4 alkoxy group and R₂=C1 to C10 straight chain or branched chain alkyl group, (CH₂CH₂—O)ₙH or (CH₂CH(CH₃)—O)ₙH and n=1 to 10; and
ii) glycerides having the structure 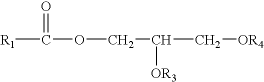
wherein R₁=C1 to C10 straight chain or branched chain alkyl optionally substituted with an hydroxyl or a C1 to C4 alkoxy group and R₃ and R₄ are individually H or R₁C(O); and
2) a source of peroxygen; and
3) a non-heme haloperoxidase catalyst having a perhydrolysis activity; and
b) combining said reaction components under aqueous reaction conditions, wherein said conditions comprising a pH range of about 2 to about 7.5, whereby a peracid is produced at a concentration of at least 500 ppb within about 5 minutes to about 2 hours of combining the reaction components.

2. The process of claim 1 wherein the pH is less than about 6.5.

3. The process of claim 2 wherein the pH range is less than about 4.5.

4. The process of claims 1-3 wherein the ester substrate is selected from the group consisting of methyl lactate, ethyl lactate, methyl glycolate, ethyl glycolate, methyl methoxyacetate, ethyl methoxyacetate, methyl 3-hydroxybutyrate, ethyl 3-hydroxybutyrate, and mixtures thereof.

5. The process of claims 1-3 wherein the glyceride is selected from the group consisting of monoacetin, diacetin, triacetin, monopropionin, glyceryl dipropionate, tripropionin, monobutyrin, glyceryl dibutyrate, tributyrin, and mixtures thereof.

6. The process of claim 4 or claim 5 wherein the non-heme haloperoxidase is derived from an organism selected from the group consisting of Pseudomonas putida and Agrobacterium tumefaciens.

7. The process of claim 6 wherein the non-heme haloperoxidase is derived from a microorganism selected from the group consisting of Psuedomonas putida 5B (NRRL-1 8668) and Agrobacterium tumefaciens C58 (ATCC 33970).

8. The process of claim 7 wherein the non-heme haloperoxidase having perhydrolysis activity is encoded by an isolated nucleic acid molecule is selected from the group consisting of:
a) an isolated nucleic acid molecule encoding a polypeptide having an amino acid sequence selected from the group consisting of SEQ ID NO: 10, SEQ ID NO: 14, SEQ ID NO: 18, SEQ ID NO: 22, and SEQ ID NO: 28; and
b) an isolated nucleic acid molecule encoding a polypeptide having at least 95% identity to an amino acid sequence selected from the group consisting of SEQ ID NO: 10, SEQ ID NO: 14, SEQ ID NO: 18, SEQ ID NO: 22, and SEQ ID NO: 28.

9. The process of claim 4 wherein the peracid produced is selected from the group consisting of peracetic acid, perpropionic acid, perbutyric acid, perlactic acid, perglycolic acid, permethoxyacetic acid, per-β-hydroxybutyric acid, and mixtures thereof.

10. The process of claim 9 wherein the peracid produced is peracetic acid.

11. A process to reduce a microbial population on a hard surface or inanimate object using an enzymatically produced aqueous peracid composition, said process comprising:
a) providing a set of peracid reaction components, said components comprising:
1. a substrate selected from the group consisting of:
i) esters having the structure 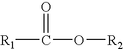
wherein R₁=C1 to C10 straight chain or branched chain alkyl optionally substituted with an hydroxyl or a C1 to C4 alkoxy group and R₂=C1 to C10 straight chain or branched chain alkyl group, (CH₂CH₂—O)ₙH or (CH₂CH(CH₃)—O)ₙH and n=1 to 10; and
ii) glycerides having the structure 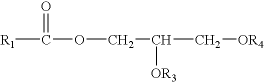
wherein R₁=C1 to C10 straight chain or branched chain alkyl optionally substituted with an hydroxyl or a C1 to C4 alkoxy group and R₃ and R₄ are individually H or R₁C(O); and
2) a source of peroxygen; and
3) a non-heme haloperoxidase catalyst having perhydrolysis activity;
b) providing a hard surface or an inanimate object having a concentration of microorganisms and/or viruses;
c) combining said reaction components under aqueous reaction conditions, wherein said conditions comprising a pH range of about 2 to about 7.5, whereby a peracid product is formed having a peracid concentration of at least 500 ppb within about 5 minutes to about 2 hours of combining the reaction components;
d) optionally diluting the said peracid product; and
e) contacting said hard surface or said inanimate object with the peracid produced in step c) or step d) within 48 hours of combining said reaction components whereby the concentration of said of microorganisms is reduced at least 3-log.

12. The process of claim 11 wherein the hard surface or the inanimate object is contacted with the peracid produced in step c) or step d) within about 30 minutes of combining said reaction components.

13. The process of claim 12 wherein the hard surface or the inanimate object is contacted with the peracid produced in step c) or step d) within about 10 minutes of combining said reaction components.

14. The process according to claims 11 to 13 wherein the concentration of said microorganisms is reduced at least 4-log.

15. The process of claim 11 wherein the pH range is less than about 6.5.

16. The process of claim 15 wherein the pH range is less than about 4.5.

17. The process of claim 11 wherein the ester substrate is selected from the group consisting of methyl lactate, ethyl lactate, ethyl acetate, methyl glycolate, ethyl glycolate, methyl methoxyacetate, ethyl methoxyacetate, methyl 3-hydroxybutyrate, ethyl 3-hydroxybutyrate, and mixtures thereof.

18. The process of claim 17 wherein the ester substrate is selected from the group consisting of ethyl lactate, ethyl acetate, and mixtures thereof.

19. The process of claim 11 wherein the glyceride substrate is selected from the group consisting of monoacetin, diacetin, triacetin, monopropionin, glyceryl dipropionate, tripropionin, monobutyrin, glyceryl dibutyrate, tributyrin, and mixtures thereof.

20. The process of claim 19 wherein the glycercide substrate is selected from the group consisting of diacetin and triacetin.

21. The process of claim 11 wherein the non-heme haloperoxidase is derived from an organism selected from the group consisting of Pseudomonas putida and Agrobacterium tumefaciens.

22. The process of claim 21 wherein the non-heme haloperoxidase is derived from a microorganism selected from the group consisting of Psuedomonas putida 5B (NRLL-18668) and Agrobacterium tumefaciens C58 (ATCC 33970).

23. The process of claim 22 wherein the non-heme haloperoxidase having perhydrolysis activity is encoded by an isolated nucleic acid molecule is selected from the group consisting of:
a) an isolated nucleic acid molecule encoding a polypeptide having an amino acid sequence selected from the group consisting of SEQ ID NO: 10, SEQ ID NO: 14, SEQ ID NO: 18, SEQ ID NO: 22, and SEQ ID NO: 28; and
b) an isolated nucleic acid molecule encoding a polypeptide having at least 95% identity to an amino acid sequence selected form the group consisting of SEQ ID NO: 10, SEQ ID NO: 14, SEQ ID NO: 18, SEQ ID NO: 22, and SEQ ID NO: 28.

24. The process of claims 23 wherein the peracid is produced at a concentration of at least 500 ppb within about 2 hours.

25. The process of claim 24 wherein the peracid is produced at a concentration of at least 1 ppm within about 2 hours.

26. The process of claim 25 wherein the peracid is produced at a concentration of at least 5 ppm within about 2 hours.

27. The process of claim 11 or 23 wherein the peracid produced is selected from the group consisting of peracetic acid, perpropionic acid, perbutyric acid, perlactic acid, perglycolic acid, permethoxyacetic acid, perβ-hydroxybutyric acid, and mixtures thereof.

28. The process according to claim 27 wherein the peracid produced is peracetic acid.

29. An isolated nucleic acid molecule encoding a polypeptide having perhydrolytic activity wherein said polypeptide comprises an amino acid sequence having at least 98% identity to SEQ ID NO: 10.

30. The isolated nucleic acid molecule of claim 29 encoding a polypeptide having an amino acid sequence as represented by SEQ ID NO: 10.

31. The process of claim 11, further comprising combining the peracid product of step (c), with one or more additional agents, including an antiseptic, disinfectant, virucide, biocide, antimicrobial agent, or mixtures thereof.

32. The process of claim 31, wherein the additional agent is a virucide selected from the group consisting of alcohols, ethers, chloroform, formaldehyde, phenols, beta propiolactone, iodine, chlorine, mercury salts, hydroxylamine, ethylene oxide, ethylene glycol, quaternary ammonium compounds, enzymes, and detergents.

33. The process of claim 31, wherein the additional agent is a biocide selected from the group consisting of chlorine, chlorine dioxide, chloroisocyanurates, hypochlorites, ozone, acrolein, amines, chlorinated phenolics, copper salts, organo-sulphur compounds, and quaternary ammonium salts.
